(19) United States
(12) Patent Application Publication
(10) Pub. No.: US 2025/0231751 A1
(43) Pub. Date: Jul. 17, 2025

(54) STORAGE MEDIUM AND CONTROL METHOD

(71) Applicant: CANON KABUSHIKI KAISHA, Tokyo (JP)

(72) Inventor: TAKESHI HAYAKAWA, Kanagawa (JP)

(21) Appl. No.: 19/018,358

(22) Filed: Jan. 13, 2025

(30) Foreign Application Priority Data
Jan. 16, 2024 (JP) 2024-004354

(51) Int. Cl. G06F 8/61; G06F 3/12

(52) U.S. Cl. CPC G06F 8/61; G06F 3/1203; G06F 3/1226

(57) ABSTRACT

A storage medium storing a program by which the computer of the first information processing apparatus is controlled to display, even in a case where the one or plurality of communication apparatuses discovered through the search performed by the first information processing apparatus includes a communication apparatus incompatible with the predetermined program, the one or plurality of communication apparatuses including the communication apparatus incompatible with the predetermined program on the first screen, and the computer of the second information processing apparatus is controlled to display, in a case where the one or plurality of communication apparatuses discovered through the search performed by the second information processing apparatus includes a communication apparatus incompatible with the predetermined program, the one or plurality of communication apparatuses excluding the communication apparatus incompatible with the predetermined program on the second screen.

### BACKGROUND

### Field of the Disclosure

The present disclosure relates to a storage medium and a control method.

### Description of the Related Art

Japanese Patent Application Laid-Open No. 2017-219961 discusses a technique for launching a second program from a first program in a coordinated manner.

As configurations where a first program performs processing relating to a second program become prevalent, there is a growing demand for improved usability of these configurations.

### SUMMARY

Embodiments of the present disclosure are directed to improving the usability of a configuration where a first program performs processing relating to a second program.

Embodiments of the present disclosure provide a non-transitory computer-readable storage medium storing a predetermined program configured to run on an operating system (OS), the predetermined program being configured to cause a computer of a first information processing apparatus, having a first operating environment on a first OS running as a host OS but not on a guest OS, to execute a first control method, the first control method comprising: displaying one or a plurality of communication apparatuses discovered through a search performed based on an instruction from the predetermined program running in the first operating environment on a first screen, accepting selection of a communication apparatus from the one or plurality of communication apparatuses displayed on the first screen, and performing, in a case where the communication apparatus selected from the one or plurality of communication apparatuses displayed on the first screen is incompatible with the predetermined program, processing relating to another program different from the predetermined program, the predetermined program being configured to cause a computer of a second information processing apparatus, having a second operating environment on a second OS running as the host OS and on the guest OS, to execute a second control method, the second control method comprising: displaying one or a plurality of communication apparatuses discovered through a search performed based on an instruction from the predetermined program running in the second operating environment on a second screen and accepting selection of a communication apparatus from the one or plurality of communication apparatuses displayed on the second screen, wherein the computer of the first information processing apparatus is controlled to display, even in a case where the one or plurality of communication apparatuses discovered through the search performed by the first information processing apparatus includes a communication apparatus incompatible with the predetermined program, the one or plurality of communication apparatuses including the communication apparatus incompatible with the predetermined program on the first screen, and wherein the computer of the second information processing apparatus is controlled to display, in a case where the one or plurality of communication apparatuses discovered through the search performed by the second information processing apparatus includes a communication apparatus incompatible with the predetermined program, the one or plurality of communication apparatuses excluding the communication apparatus incompatible with the predetermined program on the second screen.

Further features of the present disclosure will become apparent from the following description of exemplary embodiments with reference to the attached drawings.

### BRIEF DESCRIPTION OF THE DRAWINGS

FIG. 1 is a diagram illustrating an example of a configuration of a communication system.

FIG. 2 is a diagram illustrating a wireless connection sequence in a Wi-Fi Direct (WFD) mode.

FIGS. 3A and 3B are diagrams illustrating software configurations of an information processing apparatus.

FIG. 4 is a diagram illustrating a software configuration of a print application.

FIG. 5 is a flowchart illustrating an example of a procedure for printer discovery processing.

FIG. 6 is a diagram illustrating an example of a printer registration screen.

FIG. 7 is a flowchart illustrating an example of a procedure for printer registration processing.

FIGS. 8A and 8B are diagrams illustrating examples of messages displayed during printer registration.

### DESCRIPTION OF THE EMBODIMENTS

Hereinafter, exemplary embodiments will be described in detail with reference to the accompanying drawings. The exemplary embodiments do not limit the disclosure. Although a plurality of features are described in the exemplary embodiments, all of the plurality of features are not necessarily essential, and the plurality of features may be arbitrarily combined. In the accompanying drawings, the same or similar components are denoted by the same reference numerals, and the redundant description will be omitted.

It should be understood that embodiments of the present disclosure include modifications and improvements to the exemplary embodiments described below based on the knowledge of those skilled in the art without departing from the scope of the present disclosure.

An information processing apparatus and a communication apparatus included in a communication system according to a first exemplary embodiment will be described. In the present exemplary embodiment, a smartphone is described as an example of the information processing apparatus. However, this is not restrictive, and various devices, such as a mobile terminal, a laptop personal computer (PC), a tablet terminal, a personal digital assistant (PDA), and a digital camera are applicable. For the communication apparatus, various devices that wirelessly communicate with the information processing apparatus are applicable. Examples include printers, such as an inkjet printer and an electrophotographic printer. Aside from printers, the communication apparatus is also applicable to scanners, copying machines, facsimile apparatuses, mobile terminals, smartphones, laptop PCs, tablet terminals, PDAs, digital cameras, music player devices, television sets, and smart speakers. Other applicable examples may include a multifunction peripheral with a plurality of functions, such as a copying function, a facsimile (FAX) function, a print function, and a scanner function. In the present exemplary embodiment, the communication apparatus is a multifunction printer with a print function and a scanner function.

### <Hardware Configuration of Apparatuses>

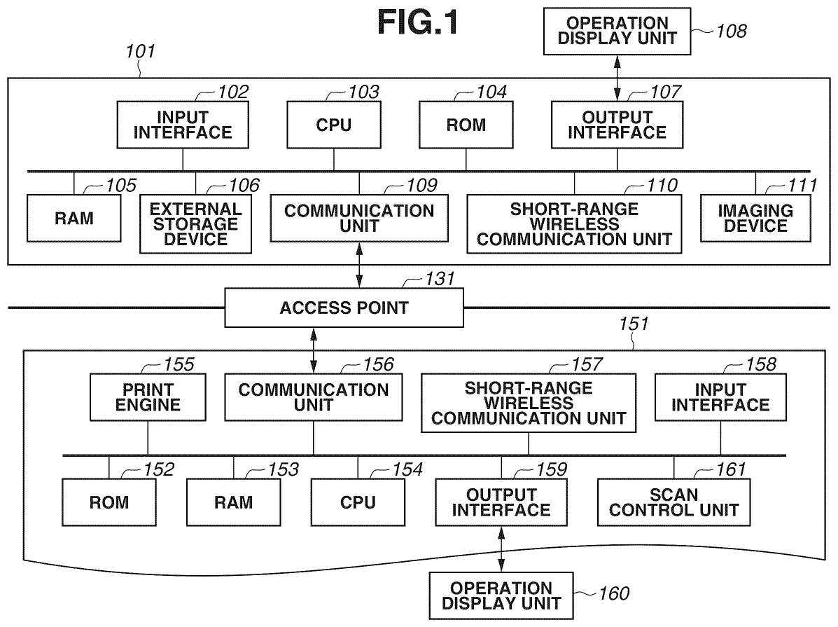

A configuration of the information processing apparatus included in the communication system according to the present exemplary embodiment and the communication apparatus that communicate with the information processing apparatus will be described with reference to the block diagram of FIG. 1. While the present exemplary embodiment will be described by using the following configuration as an example, the functions are not particularly limited to those illustrated in the diagram.

An information processing apparatus 101 includes an input interface 102, a central processing unit (CPU) 103, a read-only memory (ROM) 104, a random access memory (RAM) 105, an external storage device 106, an output interface 107, an operation display unit 108, a communication unit 109, a short-range wireless communication unit 110, and an imaging device 111.

The input interface 102 is an interface for accepting data input and operation instructions from the user, and includes a physical keyboard, buttons, and/or a touchscreen. The output interface 107 to be described below and the input interface 102 may be integrally configured in such a manner that screen output and the acceptance of operations from the user are performed by the same component.

The CPU 103 is a system control unit and controls the entire information processing apparatus 101.

The ROM 104 stores fixed data, such as control programs to be executed by the CPU 103, data tables, and a built-in operating system (OS) program. In the present exemplary embodiment, the control programs stored in the ROM 104 perform software execution control, such as scheduling, task switching, and interrupt processing under the management of the built-in OS stored in the ROM 104. In the present exemplary embodiment, the OS that is stored in the ROM 104 and runs on the information processing apparatus 101 is Android (registered trademark) OS provided by Google LLC or Chrome (registered trademark) OS provided by Google LLC. In a case where the OS running on the information processing apparatus 101 is Chrome OS, the ROM 104 also stores a virtual Android OS for running Android OS applications to be described below on the information processing apparatus 101.

The RAM 105 includes a static random access memory (SRAM) using a backup power supply (primary battery for data backup). The RAM 105 retains data with the not-illustrated primary battery for data backup, and thus stores important data, such as program control variables, in a nonvolatile manner. A memory area for storing setting information about the information processing apparatus 101 and management data on the information processing apparatus 101 is also allocated in the RAM 105. The RAM 105 is also used as a main memory and a work memory of the CPU 103.

The external storage device 106 includes an application program (hereinafter, referred to as a communication application 400) having a function of communicating with a communication apparatus 151. Specifically, the communication application 400 is an application that has a print function for causing the communication apparatus 151 to perform printing and a scan function for causing the communication apparatus 151 to perform a scan. However, such a configuration is not restrictive. The communication application 400 may be an application having either one of the print and scan functions, or an application including other functions. The external storage device 106 stores various programs including a print information generation program that generates print information interpretable by the communication apparatus 151, and an information transmission and reception control program that performs transmission and reception to/from the communication apparatus 151 connected via the communication unit 109. The external storage device 106 also stores various types of information to be used by the programs. The external storage device 106 also stores image data acquired from other information processing apparatuses and the Internet via the communication unit 109. In the present exemplary embodiment, the communication application 400 is an Android OS application.

The output interface 107 is an interface that controls data display and notification of a state of the information processing apparatus 101 by the operation display unit 108.

The operation display unit 108 includes a light-emitting diode (LED) and a liquid crystal display (LCD), and displays data and notifies the state of the information processing apparatus 101. A software keyboard including keys, such as numeric keys, mode setting keys, an enter key, a cancel key, and a power key, may be disposed on the operation display unit 108 to accept user input via the operation display unit 108.

The communication unit 109 is a component for connecting to devices, such as the communication apparatus 151, and performing data communication. For example, the communication unit 109 is able to connect to an access point (not illustrated) inside the communication apparatus 151. The connection between the communication unit 109 and the access point inside the communication apparatus 151 enables mutual communication between the information processing apparatus 101 and the communication apparatus 151. In the following description, an access point may be referred to as an AP. The communication unit 109 may communicate directly with the communication apparatus 151 by wireless communication, or communicate via an access point 131 outside the information processing apparatus 101 and outside the communication apparatus 151. In the present exemplary embodiment, the Institute of Electrical and Electronics Engineers (IEEE) 802.11 series communication standards are used as the wireless communication method. The IEEE 802.11 series communication standards are synonymous with Wi-Fi (registered trademark).

Examples of the access point 131 may include devices, such as a wireless local area network (LAN) router. In the present exemplary embodiment, a method where the information processing apparatus 101 and the communication apparatus 151 are directly connected without the intervention of an external access point will be referred to as a direct connection method. A method where the information processing apparatus 101 and the communication apparatus 151 are connected via the external access point 131 will be referred to as an infrastructure connection method.

The short-range wireless communication unit 110 is a component for connecting wirelessly to devices, such as the communication apparatus 151, at a short distance and performing data communication. The short-range wireless communication unit 110 communicates using a communication method different from that of the communication unit 109. Examples of the short-range wireless communication method used by the short-range wireless communication unit 110 include Bluetooth® and near field communication (NFC). Bluetooth® may be Bluetooth® Classic or Bluetooth® Low Energy. The short-range wireless communication unit 110 is able to communicate with a short-range wireless communication unit 157 inside the communication apparatus 151.

The imaging device 111 is a device for converting an image captured by an image sensor into digital data. The digital data is once stored in the RAM 105. A program executed by a CPU 103 then converts the digital data into a predetermined image format, and the resulting data is stored in the external storage device 106 as image data.

A ROM 152 stores fixed data, such as control programs to be executed by the CPU 154, data tables, and an OS program.

The communication apparatus 151 includes the ROM 152, a RAM 153, the CPU 154, a print engine 155, a communication unit 156, the short-range wireless communication unit 157, an input interface 158, an output interface 159, an operation display unit 160, and a scan control unit 161. When a connection mode (communication mode) is set, the communication apparatus 151 is able to operate in the set connection mode.

The communication unit 156 is a component for the communication apparatus 151 to communicate with other devices. In the present exemplary embodiment, the communication unit 156 communicates according to the IEEE 802.11 series communication standards. As an internal access point of the communication apparatus 151, the communication unit 156 includes an access point for connecting to devices, such as the information processing apparatus 101. The access point is able to connect to the communication unit 109 of the information processing apparatus 101. The communication unit 156 may communicate directly with the information processing apparatus 101 by wireless communication, or communicate via the access point 131. The communication unit 156 may include hardware functioning as an access point, or may function as an access point using software for providing the access point function. In the present exemplary embodiment, the communication unit 156 and the short-range wireless communication unit 157 are implemented by a single wireless chip. More specifically, in the present exemplary embodiment, a combo chip capable of both the communication function compliant with the IEEE 802.11 series communication standards and the communication function using the short-range wireless communication method is used. However, such a configuration is not restrictive, and the communication unit 156 and the short-range wireless communication unit 157 may be implemented by respective different wireless chips.

The RAM 153 includes a dynamic RAM (DRAM) using a backup power supply. The RAM 153 retains data with the not-illustrated power supply for data backup, and thus stores important data, such as program control variables, in a nonvolatile manner. The RAM 153 is also used as a main memory and a work memory of the CPU 154. The RAM 153 stores a reception buffer for temporarily storing print information received from the information processing apparatus 101, as well as various types of information.

The ROM 152 stores fixed data, such as control programs to be executed by the CPU 154, data tables, and an OS program. In the present exemplary embodiment, the control programs stored in the ROM 152 perform software execution control, such as scheduling, task switching, and interrupt processing, under the management of a built-in OS stored in the ROM 152. A memory area storing data that is retained even without a power supply, such as setting information about the communication apparatus 151 and management data on the communication apparatus 151, is also allocated in the ROM 152.

The CPU 154 is a system control unit, and controls the entire communication apparatus 151.

The print engine 155 forms images on recording media, such as paper, using a recording agent, such as ink, based on information stored in the RAM 153 and a print job received from the information processing apparatus 101, and outputs the print result. Here, the print job transmitted from the information processing apparatus 101 is received via the communication unit 156 that communicates at higher speed than the short-range wireless communication 157, since the print job includes a large amount of transmission data and high-speed communication is desirable.

The short-range wireless communication unit 157 is a component for connecting wirelessly to a device, such as the information processing apparatus 101, at a short distance and performing data communication. The short-range wireless communication unit 157 communicates using a communication method different from that of the communication unit 156. Examples of the short-range wireless communication method used by the short-range wireless communication unit 110 is Bluetooth® and NFC. Bluetooth® may be Bluetooth® Classic or Bluetooth® Low Energy. The short-range wireless communication unit 157 is able to connect to the short-range wireless communication unit 110.

The input interface 158 is an interface for accepting data input and operation instructions from the user, and includes a physical keyboard, buttons, and/or a touchscreen. The output interface 159 and the input interface 158 may be integrally configured in such a manner that screen output and the acceptance of operations from the user are performed by the same component. The output interface 159 is an interface that controls data display and notification of the state of the communication apparatus 151 by the operation display unit 160.

The operation display unit 160 includes display units, such as an LED and an LCD, and displays data and notifies the state of the communication apparatus 151. A software keyboard including numeric keys, mode setting keys, an enter key, a cancel key, and a power key may be disposed on the operation display unit 160 to accept user inputs via the operation display unit 160.

The scan control unit 161 includes an image sensor unit (reading unit) that scans documents stacked on a not-illustrated document table or auto document feeder (ADF). The image sensor unit includes a light source for irradiating a document with light and an image sensor including elements for reading the reflected light and photoelectrically converting the light. The scan control unit 161 acquires image data by performing analog-to-digital (A/D) conversion on an analog electrical signal obtained by the image sensor unit reading a document. The scan control unit 161 also includes a circuit that performs direct memory access (DMA) transfer to store the acquired image data into the RAM 153.

### <Direct Connection Method>

Direct connection refers to a mode where apparatuses are wirelessly connected directly (i.e., in a peer-to-peer manner) without the intervention of an external device, such as the access point 131. As one of its connection modes, the communication apparatus 151 is able to operate in a mode where communication is performed through direct connection (direct connection mode). Wi-Fi communication has a plurality of modes for performing communication through direct connection, including a software AP mode and Wi-Fi Direct (registered trademark) mode. Wi-Fi Direct will hereinafter be abbreviated as WFD.

The mode where direct connection is established using WFD will be referred to as a WFD mode. WFD is a standard formulated by the Wi-Fi Alliance, included in the IEEE 802.11 series communication standards. In the WFD mode, after discovery of communication partner devices using device discovery information, the roles of a peer-to-peer (P2P) Group Owner (GO) and a P2P Client are determined before the rest of the wireless communication processing is performed. The GO corresponds to a Wi-Fi parent station (parent device), and the Client a Wi-Fi child station (child device).

The role determination corresponds to GO Negotiation in P2P, for example. In the WFD mode before the role determination, the communication apparatus 151 is neither a parent station nor a child station. Specifically, either one of the devices to communicate initially issues device discovery information to search for the device to connect to in the WFD mode. Once the other device to be the communication partner is discovered, the two devices check each other's information about services and functions that are providable. This device provision information check is optional and not mandatory. This device provision information check phase corresponds to Provision Discovery in P2P, for example. By checking each other's device provision information, the devices determine which assumes the role of the P2P Client and which assumes the role of the P2P GO. Once the Client and the GO are determined, the two devices exchange parameters for WFD communication. The P2P client and the GO perform the rest of the wireless connection processing and Internet Protocol (IP) connection processing therebetween based on the exchanged parameters. In the WFD mode, the communication apparatus 151 may always operate as the GO without performing the foregoing GO Negotiation. In other words, the communication apparatus 151 may operate in a WFD mode that is an Autonomous GO mode. Examples of the state where the communication apparatus 151 is operating in the WFD mode include where the communication apparatus 151 is operating as the GO without WFD connection established, and where the communication apparatus 151 is operating as the GO with WFD connection established.

In the software AP mode, between the devices to communicate (for example, the information processing apparatus 101 and the communication apparatus 151), either one (for example, the information processing apparatus 101) takes on the role of a client that requests various services. The other device implements the functions of a Wi-Fi access point through software settings. The software AP corresponds to a Wi-Fi parent station, and the client a Wi-Fi child station. In the software AP mode, the client searches for the device to be the software AP using device discovery information. Once the software AP is discovered, the client and the software AP go through the rest of the wireless connection processing (establish a wireless connection), and then perform IP connection processing (assign IP addresses). The commands and parameters transmitted and received in establishing the wireless connection between the client and the software AP may be ones defined by the Wi-Fi standard. A description thereof will be omitted.

In the present exemplary embodiment, in a state in which the communication apparatus 151 establishes and maintains direct connection, the communication apparatus 151 operates as the parent station within the network to which the communication apparatus 151 belongs. The parent station refers to the device that constructs the wireless network and provides parameters to be used in connecting to the wireless network for child stations. Examples of the parameters to be used in connecting to the wireless network include parameters relating to channels the parent station uses. Child stations receive the parameters and connect to the wireless network constructed by the parent station, using the channels the parent station uses. In the direct connection mode, the communication apparatus 151 operates as the parent station, and thus determines which frequency band and which channel to use for communication in the direct connection mode. In the present exemplary embodiment, the communication apparatus 151 is able to use channels corresponding to a 2.4-GHz frequency band and channels corresponding to a 5-GHz frequency band. The user can freely set which frequency band to use (i.e., a channel of which frequency band to use) through setting on a screen displayed by the communication apparatus 151. It should be noted that, in the present exemplary embodiment, the communication apparatus 151 does not use the channels corresponding to the Dynamic Frequency Selection (DFS) band in the 5-GHz frequency band for communication in the direct connection mode even in a case where 5 GHz is selected on the screen displayed by the communication apparatus 151. In other words, the communication apparatus 151 uses only the channels corresponding to the 5-GHz frequency band excluding the DFS band for communication in the direct connection mode. In a case where a channel corresponding to the DFS band is being used when radar waves in the frequency band corresponding to that channel are detected, the currently used channel is to be switched. The frequency band where such channel switching occur due to the detection of radar waves is called DFS band. In a case where, for example, a wireless chip capable of the DFS function is used, the use of the channels corresponding to the DFS band in the 5-GHz frequency band may be allowed for communication in the direct connection mode.

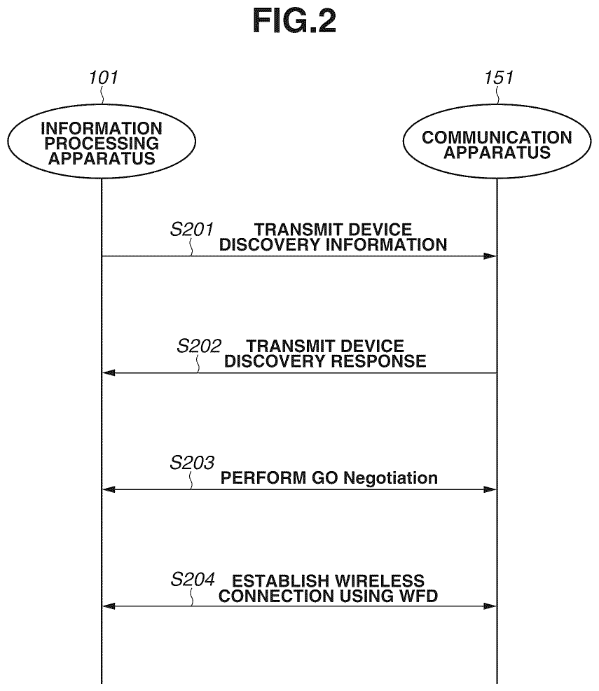

FIG. 2 is a diagram illustrating a wireless connection sequence in the WFD mode. The processing performed by each apparatus in this sequence is implemented by the CPU of the apparatus reading various programs stored in the ROM or other memory of the apparatus into the RAM and executing the programs. The processing is started when a predetermined operation for establishing a WFD connection is accepted from the user in a state where the apparatuses are running predetermined applications for performing the WFD functions. Examples of the predetermined operation for establishing a WFD connection include an operation of selecting an “enable/disable direct connection mode” button. This operation corresponds to an operation for activating the direct connection mode.

In step S201, the information processing apparatus 101 initially transmits device discovery information to search for a device supporting the WFD functions as a communication partner device.

In step S202, in a case where the received device discovery information is information transmitted using the same channel as that currently used in the direct connection mode, the communication apparatus 151, transmits a device discovery response that is a response to the device discovery information to the information processing apparatus 101. The information processing apparatus 101 thereby discovers the communication apparatus 151 as a device supporting the WFD functions. After the discovery of the communication apparatus 151 by the information processing apparatus 101, the apparatuses may exchange information about the services and functions that are providable by the respective apparatuses.

In step S203, the information processing apparatus 101 and the communication apparatus 151 perform GO Negotiation therebetween. Once the Client and the GO are determined, the Client and the GO exchange parameters for performing WFD communication. The P2P Client and GO perform the rest of the wireless communication and the IP connection processing therebetween based on the exchanged parameters. As described above, the communication apparatus 151 may operate in the Autonomous GO mode to omit GO Negotiation and always operate as the GO. When the communication apparatus 151 operates as the GO, the communication apparatus 151 determines the frequency band and the channel to be used for the WFD communication as a parent station. The communication apparatus 151 operating as the GO thus selects which of the 5- and 2.4-GHz frequency bands to use and which of the channels corresponding to the determined frequency band to use.

In step S204, the apparatuses establish a wireless connection using WDF based on the exchanged parameters and by using the channel determined by the GO.

### <Infrastructure Connection Method>

Infrastructure connection refers to a connection configuration where the devices to communicate (for example, the information processing apparatus 101 and the communication apparatus 151) connect to an access point (for example, access point 131) governing the network of the devices, and communicate via the access point. As one of its connection modes, the communication apparatus 151 is operable in a mode for communicating through infrastructure connection (infrastructure connection mode).

In infrastructure connection, each device searches for an access point using device discovery information. Once the access point is discovered, the device and the access point go through the rest of the wireless connection processing (establish a wireless connection), and then perform the IP connection processing (assign IP addresses). The commands and parameters transmitted and received between the device and the access point in establishing the wireless connection may be ones defined by the Wi-Fi standard. A description thereof will be omitted.

In the present exemplary embodiment, when the communication apparatus 151 operates in the infrastructure connection mode, the access point 131 operates as a parent station, and the communication apparatus 151 as a child station. In other words, in the present exemplary embodiment, infrastructure connection refers to the connection between the communication apparatus 151 serving as a child terminal and the device operating as a parent terminal. In a case where the communication apparatus 151 has established the infrastructure connection and the information processing apparatus 101 has also established an infrastructure connection with the access point 131, communication between the communication apparatus 151 and the information processing apparatus 101 via the access point 131 is available. Since the channel to be used for communication in the infrastructure connection is determined by the access point 131, the communication apparatus 151 performs communication in the infrastructure connection using the channel determined by the access point 131. In the present exemplary embodiment, the communication apparatus 151 is able to use the channels corresponding to the 2.4-GHz frequency band and the channels corresponding to the 5-GHz frequency band for communication in the infrastructure connection. The communication apparatus 151 is also able to use the channels corresponding to the DFS band in the 5-GHz frequency band for communication in the infrastructure connection. To communicate with the communication apparatus 151 via the access point 131, the information processing apparatus 101 recognizes that the communication apparatus 151 belongs to the network that is formed by the access point 131 and to which the information processing apparatus 101 belongs.

With the information processing apparatus 101 and the communication apparatus 151 connected to the access point 131 by infrastructure connection, the communication apparatus 151 is discovered by a broadcast performed by the information processing apparatus 101.

### <Software Configuration of Information Processing Apparatus 101>

A software configuration of the information processing apparatus 101 according to the present exemplary embodiment will be described.

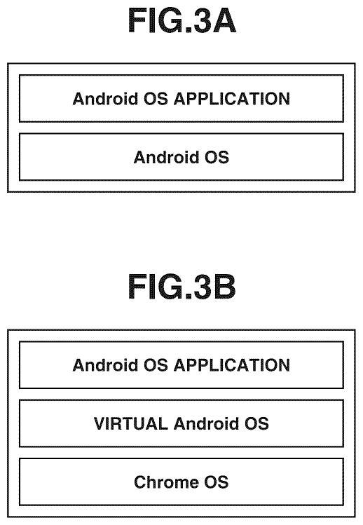

FIG. 3A illustrates an example of the software configuration of the information processing apparatus 101 in a case where a host OS running on the information processing apparatus 101 is Android OS. In this configuration, an Android OS application runs on the Android OS. In this configuration, Chrome OS is not included in the software configuration of the information processing apparatus 101. An environment where the OS running at the lowest layer of the information processing apparatus 101 is Android OS (not Chrome OS), like this configuration, will hereinafter be referred to as a first environment (also referred to as a first operating environment or real environment). A specific example of the first environment is an environment where the host OS is installed on the information processing apparatus 101 without a guest OS, and the communication application 400 runs on the host OS. Another specific example of the first environment is an environment where the host OS and a guest OS are installed on the information processing apparatus 101, and the communication application 400 runs on the host OS without the intervention of the guest OS (does not run on the guest OS). The information processing apparatus 101 having the first environment and an information processing apparatus 101 having a second environment to be described below shall be respective different information processing apparatuses 101. Specifically, processing to be described below that is performed based on the communication application 400 running in the first environment is processing performed by a first information processing apparatus 101 having the first environment. Processing that is performed based on the communication application 400 running in the second environment is processing performed by a second information processing apparatus 101 having the second environment. Note that the state where the first environment is constructed and the state where the second environment is constructed may be switched on a single information processing apparatus 101 by installing or uninstalling the host OS or the guest OS on the single information processing apparatus 101, for example. In other words, the processing to be performed based on the communication application 400 running in the first environment and the processing to be performed based on the communication application 400 running in the second environment may be both performed on a single information processing apparatus 101 depending on the environment constructed in the single information processing apparatus 101.

FIG. 3B illustrates an example of the software configuration of the information processing apparatus 101 in a case where the host OS running on the information processing apparatus 101 is Chrome OS. In this configuration, a virtual Android OS that is a virtual OS runs on Chrome OS. An Android OS application runs on the virtual Android OS. An environment where the OS running at the lowest layer of the information processing apparatus 101 is Chrome OS and a virtual Android OS runs on Chrome OS, like this configuration, will hereinafter be referred to as a second environment (also referred to as a second operating environment or virtual environment). In the present exemplary embodiment, a virtual OS refers to a program, or a guest OS, for running an application incompatible with the host OS on the host OS. The virtual OS may be the entirety of an existing OS, such as Android OS, or an existing OS from the entirety of which some modules are omitted. For example, the virtual OS is implemented using a virtualization technique, such as a virtual machine method and a container method.

The virtual Android OS may be implemented by an emulator that delegates resource management functions to Chrome OS and provides an execution environment for Android applications. In such a case, the emulator itself is not an OS, but provides a virtual Android OS, i.e., the second environment with Chrome OS included.

Issues that arise when an Android OS application is run in the second environment will be described. As an example, a case where the foregoing communication application 400 is installed and executed in each of the first and second environments will be described. Since the communication application 400 has a function of communicating with the communication apparatus 151 having a print function and printing images, the communication application 400 may be referred to a printing application. An application program developed in compliance with Android OS to run under Android OS may be referred to as an Android application.

The communication application 400 that is an Android application according to the present exemplary embodiment provides a function of printing images (hereinafter, referred to as photo printing). In response to the photo printing function being selected, the communication application 400 displays icons for pieces of image data stored in a predetermined folder on an image list screen. The communication application 400 then transmits image data selected from the image list screen to the communication apparatus 151 for printing.

In the present exemplary embodiment, suppose that there are types of printers supported by the communication application 400 and types of printers not supported by the communication application 400. The types of printers supported by the communication application 400 are, to put it another way, ones compatible with the communication application 400. The types of printers not supported by the communication application 400 are, to put it another way, ones incompatible with the communication application 400. Specifically, the types of printers supported by the communication application 400 refer to all printer models that perform inkjet printing (inkjet printers), provided by the vendor who provides the communication application 400, and certain specific printer models that perform electrophotographic printing (electrophotographic printers), provided by the vendor who provides the communication application 400. The types of printers not supported by the communication application 400 specifically refer to the printers that perform electrophotographic printing, provided by the vendor who provides the communication application 400, except for certain specific models.

The types of printers not supported by the communication application 400 may be supported by another application provided by the vendor who provides the communication application 400. In a case where the user wants to transmit a job to a type of printer not supported by the communication application 400, it is desirable that the other application is launched. In other words, in a case where a type of printer not supported by the communication application 400 is selected on a screen displayed by the communication application 400, it is desirable that the communication application 400 performs processing for launching the other application.

However, due to incompatibility in the second environment, the other application is unable to run in the second environment. More specifically, while the other application is able to transmit a job to the printer models supported by that application in the first environment, transmission to a job even to the supported printer models in the second environment may be not performable by the other application. This can, by extension, confuse the user if the communication application 400 displays the printer models not supported by the communication application 400 as selectable even though the other application is unable to transmit a job to the printer models not supported by the communication application 400 in the second environment.

In the present exemplary embodiment, the communication application 400 is then controlled to not display the printer models not supported by the communication application 400 as selectable in the second environment. Specifically, in the second environment, a search result screen is controlled to not display the printer models not supported by the communication application 400 among the devices discovered by a search performed by the communication application 400. This leads to displaying of the printers that are available as job transmission destinations in the second environment, whereby any confusion for the user is eliminated.

A method called broadcast search has heretofore been known as a method for the information processing apparatus 101 to search for a communication partner device, using the communication application 400. A broadcast search is a method for discovering devices by transmitting a broadcast search packet and receiving responses. Specifically, in a broadcast search, the communication application 400 initially executes a socket application programming interface (API). The communication application 400 thereby instructs the OS of the information processing apparatus 101 to transmit a broadcast search packet. The OS then transmits the broadcast search packet to the access point (here, access point 131) that forms the network to which the information processing apparatus 101 belongs (is connected).

A broadcast search packet is a packet where a broadcast search-specific value corresponding to the absence of specification of a packet transmission destination is set in an area for storing an IP address. In the present exemplary embodiment, the content of the broadcast search packet is specified by the communication application 400. In other words, devices that interpret the content of the broadcast search packet are ones compatible with the communication application 400. A specific example of a device compatible with the communication application 400 is a printing apparatus provided by the vendor of the communication application 400. In the present exemplary embodiment, the communication apparatus 151 is a device compatible with the communication application 400. The access point 131 receiving the broadcast search packet transmits the broadcast search packet to all devices belonging to the network formed by the access point 131. In a case where a device that is able to interpret the broadcast search packet receives the broadcast search packet, the device transmits a response to the information processing apparatus 101 that is the sender of the broadcast search packet via the access point 131. The OS of the information processing apparatus 101 receives the response and transmits the received response to the communication application 400. The information processing apparatus 101 thereby discovers each responding device using the communication application 400, and perform processing based on the result of the broadcast search.

Specific examples of the processing based on the search result include processing for displaying the search result and processing for communicating with the device discovered by the search.

A method called multicast search has been known as a method for the information processing apparatus 101 to search for communication partner devices using the communication application 400. A multicast search is a method for discovering devices by transmitting a multicast search packet and receiving responses. Specifically, in a multicast search, the communication application 400 initially executes the socket API and thereby instructs the OS of the information processing apparatus 101 to transmit a multicast search packet. The OS then transmits the multicast search packet to the access point (here, access point 131) that forms the network to which the information processing apparatus 101 belongs (is connected). A multicast search packet is a packet where a multicast search-specific value corresponding to the specification of certain types of devices as packet transmission destinations is set in an area for storing an IP address. In the present exemplary embodiment, the content of the multicast search packet is specified by the communication application 400. In other words, devices that is able to interpret the content of the multicast search packet are ones compliant with the communication application 400. The access point 131 receiving the multicast search packet transmits the multicast search packet to certain types of devices specified by the multicast search packet among all devices belonging to the network formed by the access point 131. In a case where a device that is able to interpret the multicast search packet receives the multicast search packet, the device transmits a response to the information processing apparatus 101 that is the sender of the multicast search packet via the access point 131. The OS of the information processing apparatus 101 receives the response and transmits the received response to the communication application 400. Consequently, the information processing apparatus 101 discovers each responding device using the communication application 400, and perform processing based on the result of the multicast search.

While the communication application 400 is in charge of specifying the content of the broadcast search packet and the multicast search packet, it is the OS running at the lowest layer of the information processing apparatus 101 that transmits the packets. In the second environment where Android OS applications run, it is therefore desirable for Chrome OS to execute the broadcast search or the multicast search. However, when an Android OS application runs in the second environment, the firewall of Chrome OS sometimes controls the execution of the broadcast search or multicast search that is instructed by the Android OS application and for which the socket API is used. This leads to an issue that when the communication application 400 is running in the second environment, the communication application 400 may be unable to perform processing based on the broadcast search or multicast search. Note that the firewall of Chrome OS does not block a broadcast search or multicast search instructed by a Chrome OS application. In a case where the information processing apparatus 101 runs a Chrome OS application on Chrome OS and the Chrome OS application instructs the socket API to perform a broadcast search or multicast search, Chrome OS is thus able to execute the broadcast search or multicast search.

In the present exemplary embodiment, the communication application 400 is capable of a device search using WFD. In a case where the information processing apparatus 101 on which the communication application 400 is running supports WFD, the communication application 400 thus instructs the OS of the information processing apparatus 101 to search for a device using WFD, receives the search result, and performs processing based on the search result.

However, devices equipped with Chrome OS and Chrome OS itself often do not support WFD and are unable to execute a device search using WFD. There is an issue that when the communication application 400 is running in the second environment, the communication application 400 may be unable to perform processing based on the result of a device search using WFD.

### Configuration of Communication Application 400

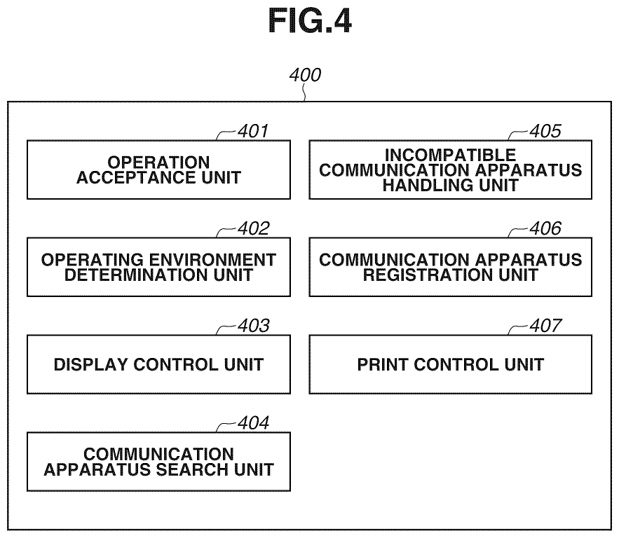

FIG. 4 illustrates a configuration of the communication application 400 stored in the ROM 104 or the external storage device 106 of the information processing apparatus 101. The communication application 400 is an application program having a print function of causing the communication apparatus 151 functioning as a printer or a printing apparatus to print image data or document data in the information processing apparatus 101. The communication application 400 also has a function of capturing image data or document data scanned by the communication apparatus 151 into the information processing apparatus 101.

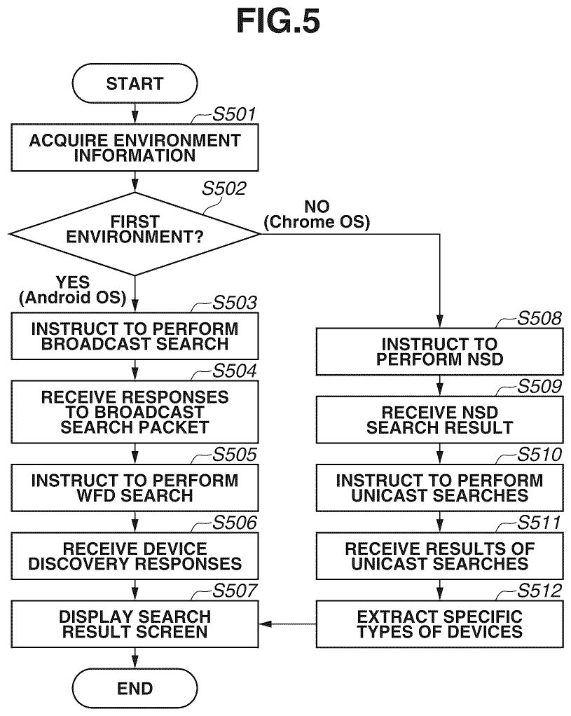

The communication application 400 includes an operation acceptance unit 401, an operating environment determination unit 402, a display control unit 403, a communication apparatus search unit 404, an incompatible communication apparatus handling unit 405, a communication apparatus registration unit 406, and a print control unit 407. The functions of these program modules are implemented by the CPU 103 executing the respective program modules. In the present exemplary embodiment, the communication application 400 accepts operations made on the operation display unit 108, using the operation acceptance unit 401. The communication application 400 determines whether the current operating environment of the communication application 400 is the first environment provided by Android OS or the second environment provided by the virtual Android OS constructed on Chrome OS, using the operating environment determination unit 402. The determination is made based on a response acquired as a result of an inquiry to the OS, or by referring to a predetermined storage location. For example, the operating environment determination unit 402 makes the determination of step S502 in FIG. 5 to be described below.

The display control unit 403 controls display of the communication application 400 on the operation display unit 108. In particular, the display control unit 403 displays a list of searched printers (communication apparatuses 151) on the operation display unit 108 of the information processing apparatus 101 as a search result screen. In a case where processing by the incompatible communication apparatus handling unit 405 to be described below involves display, the display control unit 403 controls the display as well.

The communication apparatus search unit 404 searches for (or discover) printers (communication apparatuses 151) that is able to connect to the information processing apparatus 101 and be used from the communication application 400, by a procedure described below with reference to FIG. 5. For example, the communication apparatus search unit 404 functions as the information processing apparatus 101 in the procedure of FIG. 2 and searches for communication apparatuses 151.

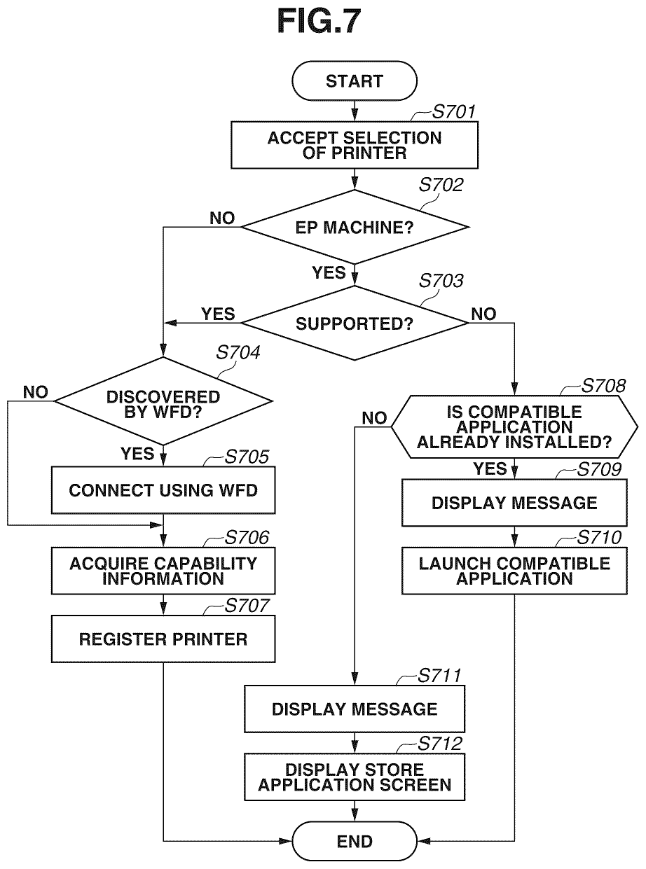

The communication apparatus registration unit 406 registers a communication apparatus 151 selected from the printers discovered by the search as a printer to be used from the communication application 400. The registered printer thereafter is to be used without a search. For example, the communication apparatus registration unit 406 performs the processing of step S707 in FIG. 7 to be described below.

The print control unit 407 transmits data selected to be printed to the selected communication apparatus 151 for printing. Examples of the data to be printed may include document data and image data that are stored when the communication application 400 is launched. Other examples include data acquired from a cloud server or the communication apparatus 151. Other examples include data acquired from other data sources.

In the following description, processing described to be performed by the internal components of the communication application 400 illustrated in FIG. 4 is, in a strict sense, processing implemented by the CPU 103 reading the communication application 400 stored in the ROM 104 into the RAM 105 and executing the communication application 400. For the sake of printing, the print control unit 407 generates a print job and transmits the print job to the communication apparatus 151 (i.e., printer). The communication apparatus 151 executes the received print job, whereby printing is performed. In the present exemplary embodiment, devices that the communication application 400 sets as a job transmission destination are those registered in the communication application 400. In other words, the communication application 400 is unable to transmit a job to a device unless the device is registered in the communication application 400.

### <Device Search by Communication Application 400>

FIG. 5 is a flowchart of the device search by the communication application 400 according to the present exemplary embodiment. This flowchart is implemented by the CPU 103 reading various programs stored in a memory, such as the external storage device 106, into the RAM 105 and executing the programs. Specifically, this flowchart is implemented by executing the communication application 400. In particular, the flowchart corresponds to the processing by the communication apparatus search unit 404. This processing is started when the user makes an operation to trigger the device search on a screen displayed by the communication application 400. However, such a configuration is not restrictive. For example, the processing may be started based on the launching of the communication application 400.

In step S501, the CPU 103 acquires environment information about the environment where the communication application 400 is running, by executing the API of Android OS from the communication application 400. In a case where the environment where the communication application 400 is running is the first environment, information corresponding to the first environment is acquired as the environment information. On the other hand, in a case where the environment where the communication application 400 is running is the second environment, the API executed is that of the virtual Android OS and information corresponding to the second environment is acquired as the environment information.

In step S502, the CPU 103 determines whether the environment where the communication application 400 is running is the first environment, based on the environment information acquired in step S501. In a case where the determination is YES (YES in step S502), the processing proceeds to step S503. In a case where the determination is NO (NO in step S502), the processing proceeds to step S508.

In step S503, the CPU 103 determines the content of a broadcast search packet, using the communication application 400. The CPU 103 instructs Android OS to transmit the packet having the determined content using the communication application 400 by executing the socket API from the communication application 400. In other words, the CPU 103 performs processing for a broadcast search using the communication application 400. The CPU 103 thereby transmits a broadcast search packet originated by Android OS to the access point 131. In the present exemplary embodiment, the broadcast search packet is configured in such a manner that only devices compatible with the communication application 400 respond to the packet. In the present exemplary embodiment, a plurality of types of broadcast search packets is broadcast. Specifically, the plurality of types of broadcast search packets includes a type of packet configured in such a manner that only inkjet printers respond and a type of packet configured in such a manner that only electrophotographic printers respond. A type of packet configured in such a manner that only old models of the inkjet printers can respond and/or a type of packet configured in such a manner that only new models of the inkjet printers respond may be included. Specifically, for example, the CPU 103 controls the search target devices to be different by changing port numbers set in the broadcast search packets. Accordingly, only desired devices are discovered by a broadcast search.

The CPU 103 then determine which devices (inkjet printers or electrophotographic printers) are discovered by the broadcast search.

In step S504, the CPU 103 acquires responses to the broadcast search packet from Android OS using the communication application 400. The CPU 103 thereby identifies the devices sending the responses as devices discovered by a broadcast. The responses include whether the inquiry is successful, a device type (such as printer), and a model name. The responses may include the IP addresses and/or media access control (MAC) addresses of the communication apparatuses.

In the foregoing steps S503 and S504, a configuration for performing processing for a broadcast search has been described. However, the information processing apparatus 101 may be configured to perform processing for a multicast search in the foregoing steps S503 and S504. Specifically, in step S503, the CPU 103 may determine the content of a multicast search packet using the communication application 400, and instruct Android OS to transmit the packet having the determined content using the communication application 400 by executing the socket API from the communication application 400. In step S504, the CPU 103 may acquire responses to the multicast search packet from Android OS using the communication application 400.

In step S505, the CPU 103 instructs Android OS to perform a WFD search (i.e., transmit WFD device discovery information), using the communication application 400 by executing an API for WFD. The CPU 103 thereby transmits device discovery information using Android OS. Android OS then receives device discovery responses from WFD-capable devices near the information processing apparatus 101. This processing corresponds to the processing of steps S201 and S202 in FIG. 2.

In step S506, the CPU 103 acquires the device discovery responses from Android OS using the communication application 400. The devices sending the device discovery responses are thereby identified as devices discovered by the WFD search. Here, only devices supporting the print service among the devices sending the device discovery responses may be identified as devices discovered by the WFD search. Which device supports which service is checked through communication between the devices sending the device discovery responses and the information processing apparatus 101.

In step S507 performed after step S506, the CPU 103 displays a search result screen using the communication application 400. This search result screen is a screen displaying a list of one or a plurality of devices discovered by the broadcast search and one or a plurality of devices discovered by the WFD search. Each device displayed is based on the information acquired in step S504 or S506. In a case where the processing branches from step S502 to S508, each device displayed is based on information acquired in step S509 or S511 to be described below, the information indicating a device extracted in step S512. The foregoing list may be displayed in such a manner that the one or plurality of devices discovered by the broadcast search and the one or plurality of devices discovered by the WFD search are distinguishable. Specifically, for example, on the search result screen, display items corresponding to the devices discovered by the broadcast search may be accompanied with an icon corresponding to being a device discovered by a broadcast search. Similarly, on the search result screen, display items corresponding to the devices discovered by the WFD search may be accompany with an icon corresponding to being a device discovered by a WFD search. The list may be displayed on the search result screen in such a manner that inkjet printers and electrophotographic printers are distinguishable. The CPU 103 accepts selection of one of the devices displayed on the search result screen from the user, using the communication application 400.

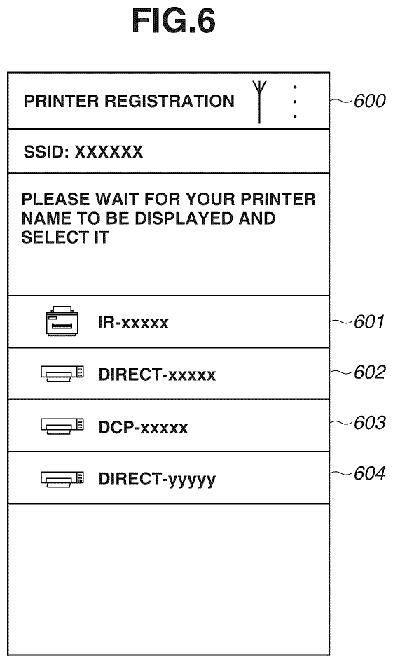

FIG. 6 illustrates a display example in step S507. The operation display unit 108 of the information processing apparatus 101 displays a screen 600 that is a search result screen. The screen 600 displays printer registration as a title. This screen 600 further displays a list of printers (communication apparatuses) discovered by the searches illustrated in FIG. 5. Items 601 to 604 correspond to respective printers discovered. Each item is displayed with identification information about the corresponding printer. The identification information displayed here is a model name, for example, whereas other information, such as a service set identifier (SSID) and a MAC address, may be displayed. As described above, inkjet printers and electrophotographic printers are distinguishably displayed here with respective different icons. The distinction may be made, for example, based on the model names received as search responses. The user can select a desired printer from the printer list by tapping on the field of the desired printer. As described above, the search methods to be performed and printers identified to be displayed on the search result screen from the discovered printers differ depending on whether the operating environment of the communication application 400 is the first environment or the second environment. The printers displayed on the screen 600 thus differ depending on whether the operating environment of the communication application 400 is the first environment or the second environment.

In a case where the determination of step S502 is NO (NO in step S502), i.e., in a case where the current operating environment is the second environment, the processing proceeds to step S508. In step S508, the CPU 103 performs processing for searching for devices on the network to which the information processing apparatus 101 belongs using the communication application 400 by using an API different from the socket API. Specifically, the API used here is a network service discovery (NSD) API. In a case where the NSD API is executed from the communication application 400, a search called NSD is performed. NSD is a multicast search performed using a DNS based service discovery protocol. NSD is a search that is performed based on instructions from the communication application 400 even in the second environment. Specifically, in this processing, when the communication application 400 executes the NSD API, the virtual Android OS instructs Chrome OS to perform NSD. Chrome OS then performs NSD and thereby discovers devices that are on the network to which the information processing apparatus 101 belongs and support NSD. In executing the NSD API, the communication application 400 specifies devices corresponding to which service, to search for by NSD. For example, the communication application 400 specifies the service through protocol specification. For that purpose, in the present exemplary embodiment, the communication application 400 specifies Internet Printing Protocol (IPP) to specify a search for devices capable of a printing service (i.e., printers).

In issuing search instructions using the socket API, the communication application 400 specifies an IP address to specify devices to transmit a packet to. In issuing search instructions using the NSD API, the communication application 400 does not specify any IP address.

In step S509, the CPU 103 receives information about the discovered devices as an NSD search result, using the communication application 400. Specific examples of the information acquired here include the IP addresses, port numbers, and service names of the discovered devices.

In step S510, the CPU 103 performs processing for performing a unicast search for one or a plurality of devices discovered by NSD. In the present exemplary embodiment, the CPU 103 performs processing for performing unicast searches for all the devices discovered by NSD. However, such a configuration is not restrictive. The CPU 103 may perform processing for performing unicast searches for some of the devices discovered by NSD. A unicast search refers to a method for searching the network to which the information processing apparatus 101 belongs, with the IP address of a device to be searched for specified. The IP addresses of the devices discovered by NSD have been acquired as the NSD search result by the communication application 400. Thus, the devices discovered by NSD is searched for again by a unicast search. Note that the scope of search by a broadcast search is with the subnetwork to which the information processing apparatus 101 belongs. By contrast, the scope of search by a unicast search is not limited to within the subnetwork to which the information processing apparatus 101 belongs but includes other subnetworks connected to the subnetwork. A subnetwork refers to a unit of network constituted by a single access point. A unicast search is performed based on instructions from the communication application 400 even in the second environment. Specifically, in this processing, the CPU 103 determines the content of a unicast search packet using the communication application 400. The CPU 103 then executes the socket API and thereby instructs the vertical Android OS to transmit the unicast search packet having the determined content, using the communication application 400. The unicast search packet is a packet where a unicast search-specific value corresponding to the specification of a packet transmission destination (in other words, the address of the device to be searched) is set in an area for storing an IP address. In the present exemplary embodiment, the unicast search packet is configured in such a manner that only a device compatible with the communication application 400 responds to the packet. In the present exemplary embodiment, a plurality of types of unicast search packets is transmitted to a single device. Specifically, the plurality of types of unicast search packets includes a type of packet configured in such a manner that only inkjet printers respond to and a type of packet configured in such a manner that only electrophotographic printers respond to. A type of packet configured in such a manner that only old models of inkjet printers respond to and a type of packet configured in such a manner that only new models of inkjet printers respond to may be included. Thus, desired devices are discovered by unicast searches. The CPU 103 then determines which device (inkjet printer or electrophotographic printer) is discovered by the unicast search. In the present exemplary embodiment, the content of a unicast search packet differs from that of a broadcast search packet only in the IP address indicating the transmission destination of the packet. The virtual Android OS then instructs Chrome OS to perform a unicast search. Chrome OS performs a unicast search by transmitting the unicast search packet. A response from the device that is on the network to which the information processing apparatus 101 belongs and that corresponds to the IP address specified in the unicast search packet is thereby received, and the device is discovered.

In step S511, as a result of the unicast searches, the CPU 103 acquires information about devices discovered by the unicast searches, using the communication application 400. Specific examples of the information acquired here include the IP addresses, MAC addresses, model names, and serial numbers of the discovered devices. Performing unicast searches after NSD leads to identifying of devices compatible with the communication application 400 among the devices discovered by NSD. Also, information not acquirable by NSD is acquired.

In step S512, the CPU 103 extracts (identifies) specific types of devices from the results of the unicast searches acquired in step S511. In the present exemplary embodiment, the specific types of devices refer to the types of printers supported by the communication application 400 described above. In other words, printers not extracted by this processing are types of printers not supported by the communication application 400 among the devices discovered by the unicast searches. Such a configuration is not restrictive. The types of printers supported by the communication application 400 may be some of the types of printers that are provided by the vendor who provides the communication application 400 and perform inkjet printing. The communication application 400 stores identification information for identifying the types of printers supported by the communication application 400 in advance, and makes this determination based on the identification information. Specific examples of the identification information include model names.

In step S507 performed after step S512, the CPU 103 displays a search result screen using the communication application 400. This search result screen is a screen displaying a list of devices extracted in step S512 among the devices discovered by the unicast searches. In other words, the display of the search result screen is controlled in such a manner that even in a case where a certain type of device is discovered by a unicast search, the certain type of device is not included. Such a configuration prevents a device that is unable (or difficult) to be registered as a job transmission destination of an application compatible with the second environment from being selected in the second environment. The search result screen may display the list in such a manner that inkjet printers and electrophotographic printers are distinguishable. The CPU 103 then accepts selection of one of the devices displayed on the search result screen from the user, using the communication application 400. In a case where the results of the unicast searches acquired in step S511 include a type of printer not supported by the communication application 400, a message that a type of printer not supported by the communication application 400 is discovered may be displayed on the search result screen using the communication application 400. There is a possibility that a job is transmitted to a type of printer not supported by the communication application 400 in the second environment by using a print function provided by Chrome OS. For such a reason, for example, the communication application 400 may display a message on the search result screen to inform the user that the type of printer not supported by the communication application 400 still possibly perform printing if the print function provided by Chrome OS is used. The print function provided by Chrome OS is implemented by a standard print application program of the host OS (here, Chrome OS). Like the host OS, the standard print application program of the host OS is a program installed on the information processing apparatus 101 in advance when the information processing apparatus 101 is delivered. In other words, the standard print application program of the host OS is an application to not be installed by a store application that is an application for installing various applications on the information processing apparatus 101 via the Internet. The print function provided by Chrome OS is a function implemented using IPP. Specifically, for example, the print function provided by Chrome OS performs a search for a target printer to transmit a print job to and transmits the print job using IPP. The standard print application program of the host OS is thus a program that performs the foregoing processing using IPP.

As described above, in the procedure of FIG. 5, whether to perform a broadcast search is switched based on the environment where the communication application 400 is running. Specifically, a broadcast search is performed based on the fact that the environment where the communication application 400 is running is the first environment. A broadcast search is not performed and other processing is performed instead based on the fact that the environment where the communication application 400 is running is the second environment. Specific examples of the other processing include an NSD search and a unicast search. Moreover, whether to display all printers discovered by a search on the search result screen or display only types of printers supported by the communication application 400 among the printers discovered by a search on the search result screen is switched based on the environment where the communication application 400 is running. This enables the communication application 400 to perform appropriate processing based on the environment where the communication application 400 is running.

The communication application 400 determines which search to instruct, a broadcast search, a multicast search, or a unicast search, by using the IP address to be specified in executing the socket API. In other words, which search to instruct is determined depending on what address to specify as the IP address to be included in the packet transmitted for the search. In other words, the present exemplary embodiment is a configuration where the content of the IP address specified in the packet used for the search is switched based on the environment where the communication application 400 is running.

The processing performed based on the fact that the environment where the communication application 400 is running is the second environment is not limited to the foregoing. For example, the processing may be processing for displaying a notification screen for notifying the user that a broadcast search is unable to be performed.

In the configuration where the notification screen is displayed, an NSD search or unicast searches do not need to be performed. Alternatively, for example, the notification screen may be a screen for notifying the user that the environment where the communication application 400 is running is the second environment, or a screen for notifying the user that communication apparatuses are unable to be registered in the communication application 400. The notification screen may be a screen for prompting the user to run the communication application 400 in the first environment.

The search methods are not limited to the foregoing. For example, the processing for a broadcast search (steps S503 and S504) and the processing for a WFD search (steps S505 and S506) may be performed in reverse order. The two searches may be performed in parallel. Instead of displaying a search result screen at the end of the searches, devices discovered by the searches may be successively added to the search result screen each time a device is discovered.

The communication application 400 may be capable of accepting an operation for instructing the execution of a broadcast search and an operation for instructing the execution of a WFD search separately. In a case where the operation for instructing the execution of a broadcast search is made, the flowchart of FIG. 5 may be performed without executing the processing for a WFD search. Similarly, in a case where the operation for instructing the execution of a WFD search is made, the flowchart of FIG. 5 may be performed without executing the processing for a broadcast search. The communication application 400 may be an application capable of either one of a broadcast search and a WFD search. Specifically, in a case where the communication application 400 is an application only capable of a broadcast search, the flowchart of FIG. 5 may be performed without executing the processing for a WFD search. Similarly, in a case where the communication application 400 is an application only capable of a WFD search, the flowchart of FIG. 5 may be performed without executing the processing for a broadcast search.

The foregoing description has dealt with a configuration where the processing for unicast searches (steps S510 and S511) is performed after the processing for NSD (steps S508 and S509). However, such a configuration is not restrictive. For example, in the flowchart of FIG. 5, the search result screen may display only the types of printers supported by the communication application 400 among the devices discovered by NSD, without performing the processing for unicast searches. Here, the types of printers supported by the communication application 400 may be configured to include information corresponding to being a type of printer supported by the communication application 400 into the response to NSD. The search result screen may display only those devices identified and extracted as the types of printers supported by the communication application 400 among the devices discovered by NSD.

### Printer (Communication Apparatus) Registration Processing

FIG. 7 illustrates an example of processing for registering a printer selected from one or a plurality of printers displayed on the screen of FIG. 6. As described above, a printer, once registered, does not need to be searched for upon each use and is to be used for printing. This, of course, is predicated on the fact that the information processing apparatus 101 successfully connects to the printer, which is the communication apparatus 151. In a case where the connection fails, the information processing apparatus 101 will search for a new printer or attempt to use another printer registered.

In step S701 of FIG. 7, the CPU 103 accepts the selection of a printer on the search result screen displayed in step S507. In step S702, the CPU 103 determines whether the printer model selected in step S701 is one that performs electrophotographic printing, i.e., an electrophotographic (EP) machine. In other words, an EP machine refers to an EP printer. For example, a printer model that performs inkjet (IJ) printing is determined to not be an EP machine.

In other words, a printer model that performs IJ printing is an IJ machine. This determination may be made based on model-indicating information, such as a model name, included in the response received from the printer as a search result. In such a case, the communication application 400 stores information indicating the model name and whether the printer model is an EP machine, and make the determination by referring to the information.

In step S702, in a case where the printer model selected is determined to be one that performs EP printing (YES in step S702), the processing proceeds to step S703. In step S703, the communication application 400 determines whether the printer selected in step S701 is supported (i.e., compatible). In the present exemplary embodiment, the printers supported by the communication application 400 are all of the printer models that are provided by the vendor who provides the communication application 400 and perform IJ printing, and some of the printer models that are provided by the vendor who provides the communication application 400 and perform EP printing. However, such a configuration is not restrictive, and the printers supported by the communication application 400 may be some of the printer models that are provided by the vendor who provides the communication application 400 and perform IJ printing. In such a configuration, the determination of step S702 may be omitted, and the processing may proceed from S701 to S703. The communication application 400 stores information about the model names of the printers supported by the communication application 400 in advance, and makes the determination based on the information. In the present exemplary embodiment, as described above, the search result screen is controlled to not display printers not supported by the communication application 400 in the second environment. In the second environment, the determination of step S703 is therefore always YES. In other words, in the second environment, the processing of steps S708 to S712 to be described below will not be performed.

In a case where the determination of step S702 is NO (NO in step S702) or the determination of step S703 is YES (YES in step S703), the processing proceeds to step S704. In step S704, the CPU 103 determines whether the selected printer is one discovered by WFD. A printer discovered by WFD refers to a printer discovered in steps S505 and S506 of FIG. 5. A printer discovered by a method other than WFD refers to a printer discovered in steps S503 and 504, or S508 to S511. In a case where the selected printer is determined to be discovered by WFD (YES in step S704), the processing proceeds to step S705. In step S705, the CPU 103 connects the selected printer and the information processing apparatus 101 using WFD. In a case where the selected printer is not determined to be discovered by WFD (NO in step S704) or after the selected printer and the information processing apparatus 101 are connected using WFD (step S705), the processing proceeds to step S706. In step S706, the CPU 103 acquires capability information from the selected printer. The capability information is acquired via the connection between the selected printer and the information processing apparatus 101. Specifically, in a case where the determination of step S704 is YES, the capability information is acquired via the WFD connection between the selected printer and the information processing apparatus 101. In a case where the determination of step S704 is NO, the capability information is acquired via the infrastructure connection between the selected printer and the information processing apparatus 101, for example. In other words, the capability information is acquired via the access point to which the information processing apparatus 101 is connected. In step S707, the CPU 103 then stores the acquired information into the communication application 400, whereby the selected printer (communication apparatus) corresponding to the acquired information is registered in the communication application 400. Examples of the information to be registered may include a name, a connection destination address, and the acquired capability information. With the printer registered in the communication application 400, the communication application 400 is able to transmit various jobs, such as print jobs and scanned jobs, to the registered printer.

In a case where the determination of step S703 is NO (NO in step S703), the processing proceeds to step S708. In step S708, the CPU 103 determines whether an application (program) compatible with the selected printer other than the communication application 400 is already installed. In the present exemplary embodiment, the Android applications to be executed in the first environment include another application that supports a printer that is not supported by the communication application 400 and provided by the same vendor as that of the communication application 400. The other application is an application provided by the same vendor as that of the communication application 400.

The other application is able to register in itself a printer that is provided by the same vendor as that of the communication application 400 and incompatible with the communication application 400.

In other words, the other application is able to transmit print jobs and scan jobs to a printer that is provided by the same vendor as that of the communication application 400 and incompatible with the communication application 400. The communication application 400 then determines whether the other application compatible with the selected printer is already installed, though the communication application 400 itself is incompatible with the selected printer.

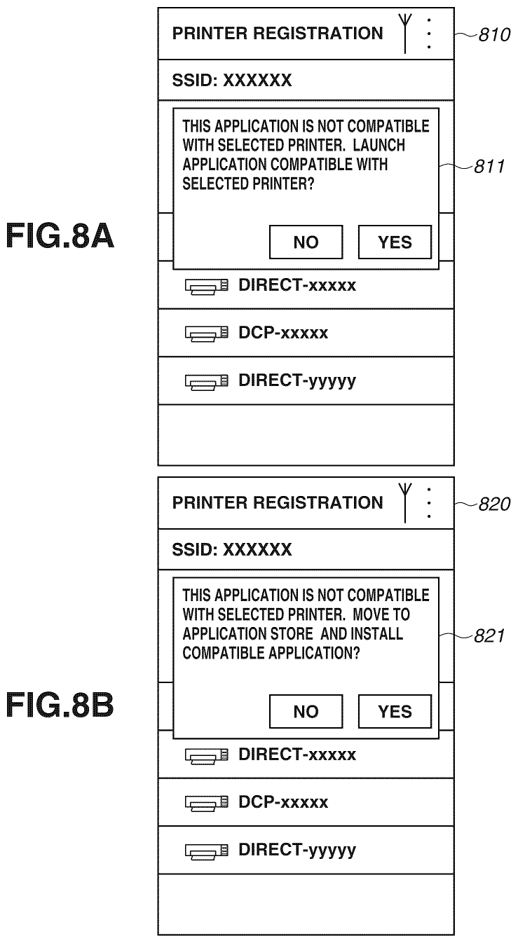

In a case where the other application is already installed (YES in step S708), the processing proceeds to step S709. In step S709, the CPU 103 displays a screen 810 including a message about it. FIG. 8A illustrates an example of the screen 810 including such a message 811. The message 811 states that the currently running communication application 400 is incompatible with (does not support) the selected printer, and includes buttons for accepting selection as to whether to launch the other, compatible application. In a case where the user selects “YES”, i.e., to launch the other application (i.e., the other program), then in step S710, the CPU 103 launches the application. The operation screen of the launched application then appears, and the user operates the operation screen to print images to be printed. In the case where this processing is executed, the communication application 400 may end processing without registering the selected printer.

In a case where, in step S708, an application compatible with the selected printer is determined to not be installed (NO in step S708), the processing proceeds to step S711. In step S711, the CPU 103 displays a screen 820 including a message about it. FIG. 8B illustrates an example of a screen 820 including such a message 821. The message 821 states that the currently running communication application 400 is incompatible with (does not support) the selected printer, and includes buttons for accepting selection as to install the other, compatible application. Installing the application involves downloading from a store application providing the application. The message thus includes a confirmation to move to the store application. Moving to a store application means that the communication application 400 connects to the store application known in advance and displays its screen. In a case where the user selects “YES”, i.e., to install the other application, then in step S712, the CPU 103 launches the store application for that application and displays the screen of the store application. The user then performs operations for downloading the intended application from the store application and installing the application.

After the installation, the CPU 103 may simply launch the installed application. In such a case, the operation screen of the launched application appears, and the user operates the operation screen to print images to be printed. In the case where this processing is performed, the communication application 400 may end processing without registering the selected printer.

As described above, according to the present exemplary embodiment, printers are searched for by using methods (or protocols) suitable for the respective first and second operating environments. Printers that is able to connect to the information processing apparatus 101 on which the communication application 400 is running are thus discovered regardless of the operating environment of the communication application 400. The search result screen is displayed by display methods suitable for the respective first and second operating environments.

Embodiments of the present disclosure can also be realized by processing in which a program for realizing one or more functions of the above-described exemplary embodiments is supplied to a system or an apparatus via a network or a storage medium, and one or more processors in a computer of the system or the apparatus read and execute the program. Embodiments of the present disclosure can also be realized by a circuit (for example, an ASIC) that realizes one or more functions.

The present disclosure is not limited to the above-described embodiments, and various modifications and variations can be made without departing from the spirit and scope of the disclosure.

Embodiment(s) of the present disclosure can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc™ (BD)), a flash memory device, a memory card, and the like.

While the present disclosure includes exemplary embodiments, it is to be understood that the disclosure is not limited to the disclosed exemplary embodiments. The scope of the following claims is to be accorded the broadest interpretation so as to encompass all such modifications and equivalent structures and functions.

This application claims the benefit of Japanese Patent Application No. 2024-004354, filed Jan. 16, 2024, which is hereby incorporated by reference herein in its entirety.

What is claimed is:

1. A non-transitory computer-readable storage medium storing a predetermined program configured to run on an operating system (OS),
the predetermined program being configured to cause a computer of a first information processing apparatus, having a first operating environment on a first OS running as a host OS but not on a guest OS, to execute a first control method, the first control method comprising:
displaying one or a plurality of communication apparatuses discovered through a search performed based on an instruction from the predetermined program running in the first operating environment on a first screen;
accepting selection of a communication apparatus from the one or plurality of communication apparatuses displayed on the first screen; and
performing, in a case where the communication apparatus selected from the one or plurality of communication apparatuses displayed on the first screen is incompatible with the predetermined program, processing relating to another program different from the predetermined program,
the predetermined program being configured to cause a computer of a second information processing apparatus, having a second operating environment on a second OS running as the host OS and on the guest OS, to execute a second control method, the second control method comprising:
displaying one or a plurality of communication apparatuses discovered through a search performed based on an instruction from the predetermined program running in the second operating environment on a second screen; and
accepting selection of a communication apparatus from the one or plurality of communication apparatuses displayed on the second screen,
wherein the computer of the first information processing apparatus is controlled to display, even in a case where the one or plurality of communication apparatuses discovered through the search performed by the first information processing apparatus includes a communication apparatus incompatible with the predetermined program, the one or plurality of communication apparatuses including the communication apparatus incompatible with the predetermined program on the first screen, and
wherein the computer of the second information processing apparatus is controlled to display, in a case where the one or plurality of communication apparatuses discovered through the search performed by the second information processing apparatus includes a communication apparatus incompatible with the predetermined program, the one or plurality of communication apparatuses excluding the communication apparatus incompatible with the predetermined program on the second screen.

2. The non-transitory computer-readable storage medium according to claim 1,
the first control method further comprising:
registering in a case where the communication apparatus selected from the one or plurality of communication apparatuses displayed on the first screen is compatible with the predetermined program, the communication apparatus selected from the one or plurality of communication apparatuses displayed on the first screen in the predetermined program; and
transmitting data to the communication apparatus registered in the predetermined program, and
the second control method further comprising:
registering the communication apparatus selected from the one or plurality of communication apparatuses displayed on the second screen in the predetermined program; and
transmitting the data to the communication apparatus registered in the predetermined program.

3. The non-transitory computer-readable storage medium according to claim 2, wherein the data transmitted to the communication apparatus registered in the predetermined program is a print job configured to cause the communication apparatus registered in the predetermined program to perform printing or a scan job configured to cause the communication apparatus registered in the predetermined program to perform a scan.

4. The non-transitory computer-readable storage medium according to claim 1, wherein the processing relating to the another program is processing for launching the another program.

5. The non-transitory computer-readable storage medium according to claim 1, wherein in a case where the another program is not installed on the first information processing apparatus, the processing relating to the another program is processing for launching a store application program configured to install the another program.

6. The non-transitory computer-readable storage medium according to claim 1, wherein the another program is a program configured to transmit the data to the communication apparatus incompatible with the predetermined program.

7. The non-transitory computer-readable storage medium according to claim 1, wherein the another program is a program provided by a vendor who provides the predetermined program.

8. The non-transitory computer-readable storage medium according to claim 1, wherein the communication apparatus compatible with the predetermined program is an inkjet printer configured to perform inkjet printing.

9. The non-transitory computer-readable storage medium according to claim 1, wherein the communication apparatus compatible with the predetermined program is a model of electrophotographic printer configured to perform electrophotographic printing.

10. The non-transitory computer-readable storage medium according to claim 1, wherein the communication apparatus incompatible with the predetermined program is a model of electrophotographic printer configured to perform electrophotographic printing.

11. The non-transitory computer-readable storage medium according to claim 1, wherein the search performed based on the instruction from the predetermined program running in the first operating environment and the search performed based on the instruction from the predetermined program running in the second operating environment are different.

12. The non-transitory computer-readable storage medium according to claim 1, wherein the search performed based on the instruction from the predetermined program running in the first operating environment includes a broadcast search or multicast search performed by a socket application programming interface (API).

13. The non-transitory computer-readable storage medium according to claim 1, wherein the search performed based on the instruction from the predetermined program running in the first operating environment includes a search using Wi-Fi Direct (registered trademark).

14. The non-transitory computer-readable storage medium according to claim 1, wherein the search performed based on the instruction from the predetermined program running in the second operating environment includes a search performed by a network service discovery API.

15. The non-transitory computer-readable storage medium according to claim 1, wherein the search performed based on the instruction from the predetermined program running in in the second operating environment includes a unicast search performed by a socket API.

16. The non-transitory computer-readable storage medium according to claim 1, wherein the first and second screens display the one or plurality of communication apparatuses in such a manner that an inkjet printer configured to perform inkjet printing and an electrophotographic printer configured to perform electrophotographic printing are distinguished.

17. The non-transitory computer-readable storage medium according to claim 1,
wherein in the first operating environment, the first OS that is the host OS is Android (registered trademark) OS, and the guest OS is not running on the host OS, and
wherein in the second operating environment, the second OS that is the host OS is Chrome (registered trademark) OS, and the guest OS is a virtual Android (registered trademark) OS.

18. The non-transitory computer-readable storage medium according to claim 1,
wherein the predetermined program is configured to determine whether an environment where the predetermined program is running is the first operating environment or the second operating environment,
wherein based on the determination that the environment where the predetermined program is running is the first operating environment, the computer of the first information processing apparatus is controlled to display, even in a case where the one or plurality of communication apparatuses discovered through the search performed by the first information processing apparatus includes the communication apparatus incompatible with the predetermined program, the one or plurality of communication apparatuses including the communication apparatus incompatible with predetermined program on the first screen, and
wherein based on the determination that the environment where the predetermined program is running is the second operating environment, the computer of the second information processing apparatus is controlled to display, in a case where the one or plurality of communication apparatuses discovered through the search performed by the second information processing apparatus includes the communication apparatus incompatible with the predetermined program, the one or plurality of communication apparatuses excluding the communication apparatus incompatible with the predetermined program on the second screen.

19. The non-transitory computer-readable storage medium according to claim 1, wherein the predetermined program is an application program for Android (registered trademark) OS.

20. A method for controlling a first information processing apparatus and a second information processing apparatus, the first information processing apparatus including a predetermined program configured to run on an OS and having a first operating environment on a first OS running as a host OS and not on a guest OS, the second information processing apparatus including the predetermined program and having a second operating environment on a second OS running as the host OS and on the guest OS, the method comprising:
displaying by the first information processing apparatus, as first displaying control, one or a plurality of communication apparatuses discovered through a search performed based on an instruction from the predetermined program running in the first operating environment on a first screen;
accepting by the first information processing apparatus, as first accepting, selection of a communication apparatus from the one or plurality of communication apparatuses displayed on the first screen;
performing, in a case where the communication apparatus selected from the one or plurality of communication apparatuses displayed on the first screen is incompatible with the predetermined program, processing, by the first information processing apparatus, relating to another program different from the predetermined program;
displaying by the second information processing apparatus, as second displaying control, one or a plurality of communication apparatuses discovered through a search performed based on an instruction from the predetermined program running in the second operating environment on a second screen; and
accepting by the second information processing apparatus, as second accepting, selection of a communication apparatus from the one or plurality of communication apparatuses displayed on the second screen,
wherein the first information processing apparatus is controlled to display, even in a case where the one or plurality of communication apparatuses discovered through the search performed by the first information processing apparatus includes a communication apparatus incompatible with the predetermined program, the one or plurality of communication apparatuses including the communication apparatus incompatible with the predetermined program on the first screen, and
wherein the second information processing apparatus is controlled to display, in a case where the one or plurality of communication apparatuses discovered through the search performed by the second information processing apparatus includes a communication apparatus incompatible with the predetermined program, the one or plurality of communication apparatuses excluding the communication apparatus incompatible with the predetermined program on the second screen.
